(19) United States
(12) Patent Application Publication
(10) Pub. No.: US 2008/0282938 A1
(43) Pub. Date: Nov. 20, 2008

(54) CEMENT MAKING METHOD

(76) Inventors: Victor H. Cifuentes, West Camp, NY (US); Kenneth A. DeWitt, JR., Schenectady, NY (US); Frederick P. Hommel, Saugerties, NY (US); Anthony Santamaria, Climax, NY (US); Barry A. Rowland, Athens, NY (US)

Correspondence Address: SCHMEISER, OLSEN & WATTS, 22 CENTURY HILL DRIVE, SUITE 302, LATHAM, NY, 12110, US

(21) Appl. No.: 12/184,692

(22) Filed: Aug. 1, 2008

Related U.S. Application Data
(63) Continuation of application No. 11/142,167, filed on Jun. 1, 2005.

(51) Int. Cl. C04B 2/10

(52) U.S. Cl. 106/751; 106/739; 106/753; 106/771

(57) ABSTRACT

A method of making cement clinker in a wet rotary kiln that includes providing raw material at the front of the kiln and adding a second group of materials for processing at an intermediate location along the kiln. This second group may include materials that improve the clinker and requires less energy to produce. A kiln system that employs this method and a cement clinker made by the method.

### RELATED APPLICATIONS

This application is a continuation of Ser. No. 11/142,167, filed on Jun. 1, 2005.

### FIELD OF INVENTION

This invention relates generally to the field of cement making. More particularly, the invention relates to methods of making cement clinker that employs the addition of materials, such as lime kiln dust (LKD), at an intermediate location on a kiln. A system that allows the use of the method and a composition of cement clinker that is produced via this method and system is also disclosed.

### BACKGROUND OF INVENTION

Current methods of making cement typically require the adding of pulverized materials, in certain ratios, having four essential ingredients: calcium, silica, aluminum, and iron to the leading (upper), input end of a rotary kiln. These ingredients are obtained from raw materials such as limestone, clay, and sand. The kiln, at its simplest, is a huge, long furnace that is a sloped, slowly-rotating cylinder.

Within the rotating kiln, intense heat at, or near, the distal (lower), discharge end of the kiln is applied to the interior of the kiln. As the raw materials make their way along the length of the rotating kiln from the leading end to the distal end, the materials are converted, chemically and materially, by the heat wherein the calcium and silica oxides in these raw materials is converted into calcium silicate, the prime ingredient in cement. The converted material emerges at the lower (flame) end of the kiln as this new substance, commonly called cement clinker. Cement clinker, with the subsequent addition of ground gypsum, becomes cement.

Other supplements, such as mill scale, shale, bauxite and fly ash may also be part of the raw material mixture that enters the leading end of the kiln. These various supplemental raw materials typically offer varying properties to the cement product that is made. Various new supplements are continually sought for their concomitant improvements and characteristics brought to the cement product and/or cement making process.

Lime kiln dust (“LKD”), which is a by-product of the lime (e.g., dolomitic lime, high-calcium lime, etc.) manufacturing process, is typically collected via air pollution control dust collection systems. Uses for LKD are continually being sought out in that large volumes of LKD are created annually by the lime manufacturing industry.

Accordingly, there is a need for a method of making cement clinker that improves beyond the existing art; perhaps employs the use of LKD; and, offers a cement clinker with improved qualities.

### SUMMARY OF INVENTION

The present invention provides a method for making cement clinker. The present invention further provides a system of equipment that employs the method and a cement clinker product that is made by the method.

A first general aspect of the invention provides a method comprising:

providing a rotary kiln configured for making cement clinker, said kiln having a first end and a second end and an interior connecting therebetween;

adding a first material to said first end;

transporting said first material within said kiln towards said second end;

adding a second material to said interior at a location between said first end and said second end, wherein said second material includes at least one from the group consisting of: CaO, MgO, Al₂O₃, and Fe₂O₃; and

processing said first and said second material in said interior, thereby resulting in cement clinker at said second end.

A second general aspect of the invention provides a composition comprising:

a first mixture of material including calcium, silica, aluminum, and iron, wherein said first mixture has been processed through an entire length of a rotary kiln; and

a second mixture of material including at least one from the group consisting of: CaO, MgO, Al₂O₃, and Fe₂O₃, wherein said second mixture has been processed through less than an entire length of said rotary kiln.

A third general aspect of the invention provides a system comprising:

a wet rotary kiln having a first end and a second distal end;

a heat source located proximate said second distal end;

a first material entry location proximate said first end; and

a second material entry location between said first end and said second distal end, configured for entry of said second material, wherein said second material includes at least one from the group consisting of: CaO, MgO, Al₂O₃, and Fe₂O₃.

A fourth general aspect of the invention provides a method of making cement clinker comprising:

providing a wet rotary kiln;

providing a slurry of first material at a first end of said kiln;

transporting said slurry of first materials from said first end to a second end of said kiln;

adding a second material in said kiln, in at least one location of said kiln between said first end and said second end; and

heating and transporting said first material and said second material towards said second end, thereby resulting in said cement clinker.

The foregoing and other features of the invention will be apparent from the following more particular description of various embodiments of the invention.

### BRIEF DESCRIPTION OF DRAWINGS

Some of the embodiments of this invention will be described in detail, with reference to the following figures, wherein like designations denote like members, wherein:

FIG. 1 depicts an elevation sectional view of an embodiment of a kiln employing the addition of material at an intermediate kiln location via scoops, in accordance with the present invention;

FIG. 2 depicts a close up diagrammatic view of a kiln system with the kiln in side view, in accordance with the present invention;

FIG. 3 depicts a close up diagrammatic view of a kiln system with the kiln in cross-sectional view, in accordance with the present invention;

FIG. 4 depicts flowchart of a method of making cement clinker, in accordance with the present invention;

FIG. 5 depicts a graph showing a gas and material temperature profile as compared to the position in the kiln, in accordance with the present invention; and

FIG. 6 depicts a graph showing gas velocity and material temperature profile as compared to the position in the kiln, in accordance with the present invention.

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of an embodiment. Although the drawings are intended to illustrate the present invention, the drawings are not necessarily drawn to scale.

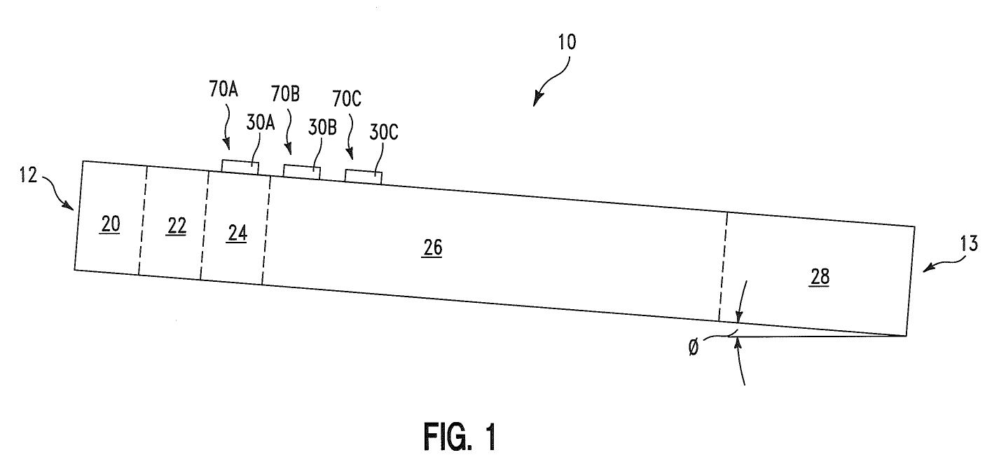

Turning to the figures for explanation, FIG. 1 shows a kiln 10 employing the method of the present invention. FIG. 1, clearly, is not drawn to scale, but is shown to depict the relative relationships of salient portions of the kiln 10, in this embodiment a wet rotary kiln 10. The kiln 10, is a long, hollow cylinder which rotates slowly during use, which is primarily for the manufacture, in this case, of cement clinker. The kiln 10 is on a slight incline, as denoted by angle φ. As with most kilns 10, there is a first, or upper, end 12 and a second, distal, lower, or discharge end 13. Raw materials are entered the kiln 10 at the first end 12, wherein the raw materials, in the making of clinker, that include at a minimum, calcium, silicon, aluminum, and iron. A powerful heat source (not shown) is provided at, or near, the second end 13. The raw materials pass down through an interior 11 of the kiln 10, starting at the first end 12, are heated by the heat source as they move ultimately towards the second end 13 wherein, having been converted chemically and materially, egress as cement clinker.

The clinker once retrieved from the kiln 10 is ground and mixed with gypsum to form Portland cement.

The embodiment of the kiln 10 shown in FIG. 1 is a wet rotary kiln 10, thereby denoted because the raw materials enter the kiln 10 as a wet slurry mixture. The length of kiln 10 is divided up into a plurality of zones, or sections. Starting at the first end 12, a first zone 20 is a wet zone 20. The wet zone 20 is followed by a second zone 22 that is a drying zone 22. The drying zone 22 is followed by a third zone 24, that is a pre-heat zone 24. The pre-heat zone 24 is followed by a fourth zone 26, that is a calcining zone 26. The calcining zone 26 is followed by a fifth zone 28, that is the burning zone 28.

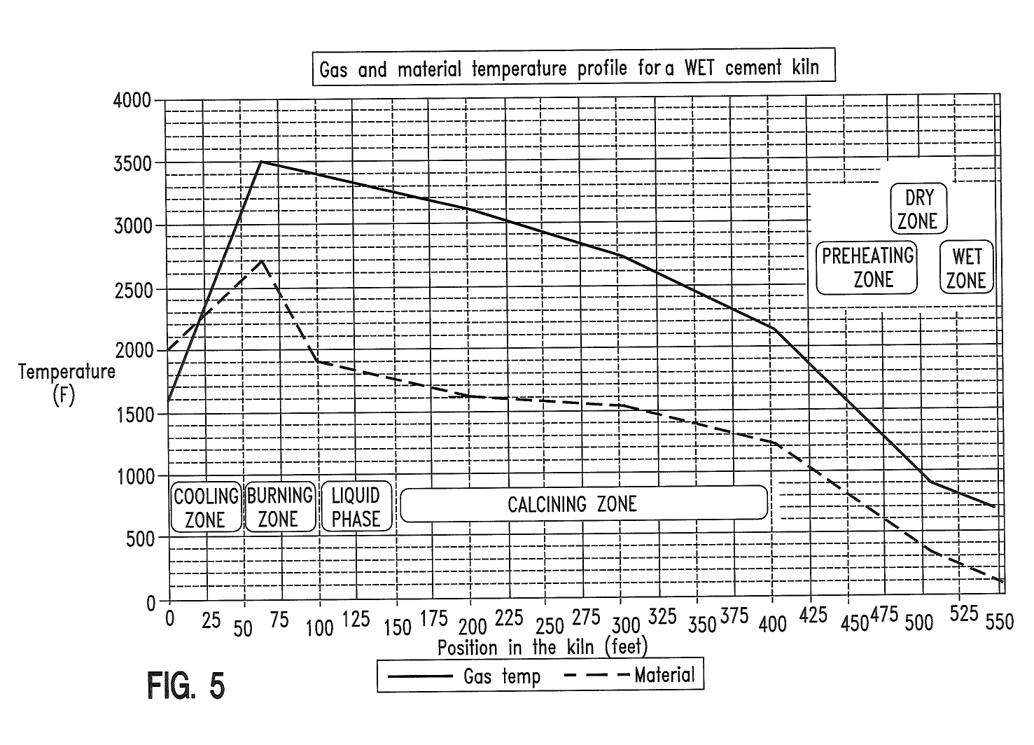

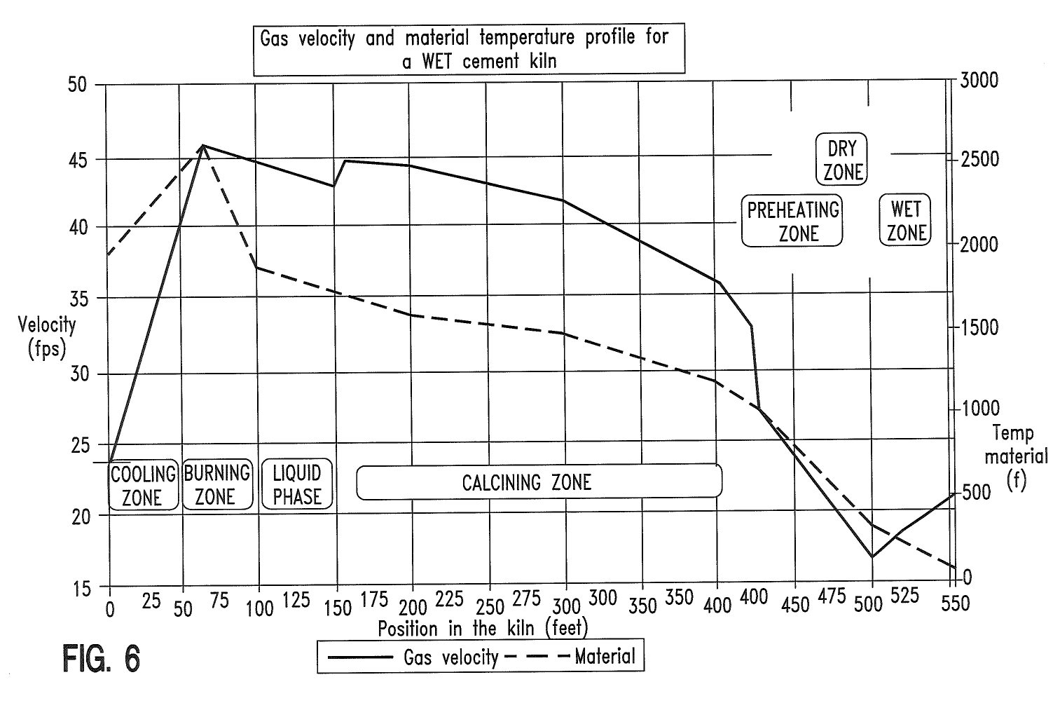

The burning zone 28 may include sub-zones that make up the burning zone 28 including a liquid phase, burning zone proper, and cooling zone (see FIGS. 5 and 6).

The various zones extend different lengths depending on various attributes of the particular wet kiln 10. Similarly, the boundaries between the different zones is not necessarily exact, nor precise.

One embodiment of a kiln 10 in the present invention using the method and system of the invention is shown in more detail in the various figures. In this embodiment, the length of the kiln 10 is 550 feet.

Turning to FIGS. 5 and 6, in particular, show various profiles and attributes of an embodiment of the kiln 10 along its 550 foot length.

In this embodiment of a 550 foot long kiln 10, the wet zone 20 extends from the start of the kiln 10 up to a length of approximately 50 feet. In the embodiment shown, wet zone 20 is 50 feet long. The gas temperature in the wet zone 20 is in range of approximately 700° F. to 1,000° F., while the material temperature in the wet zone 20 is in the range of approximately 80° F. to 400° F.

The drying zone 22 extends from the end of the wet zone 20 and extends from in the range of 50 feet up to 100 feet from the first end 12 of the kiln 10. In the embodiment shown, the drying zone 22 is 50 feet long, and extends from 50 feet to 100 feet from the first end 12. The gas temperature in the drying zone 22 is in range of approximately 1,000° F. to 1,500° F., while the material temperature in the drying zone 22 is in the range of approximately 400° F. to 800° F.

The pre-heat zone 24 extends from the end of the drying zone 22 and extends from approximately 100 feet up to 150 feet from the first end 12 of the kiln 10. In the embodiment shown, the pre-heat zone 24 is 50 feet long. The gas temperature in the pre-heat zone 24 is in range of approximately 950° F. to 1,850° F., while the material temperature in the pre-heat zone 24 is in the range of approximately 800° F. to 1,200° F.

The calcining zone 26 extends from the end of the pre-heat zone 24 and extend from approximately 150 feet up to 400 feet from the first end 12 of the kiln 10. In the embodiment shown, the calcining zone 26 extends approximately 250 feet in length. The gas temperature in the calcining zone 26 is in range of approximately 2,100° F. to 3,250° F., while the material temperature in the calcining zone 26 is in the range of approximately 1,200° F. to 1,750° F. In the calcining zone 26 virtually all the CO₂ is removed from the CaCO₃,thereby converting the CaCO₃ to CaO (i.e., calcium oxide).

The burning zone 28 extends from the end of the calcining zone 26 and extends from approximately 400 feet from the first end 12 to the second end 13 of the kiln 10. In the embodiment shown, the burning zone 28 extends approximately 150 feet in length. The burning zone 28 is made up of three sub-zones, or sections, termed an upper transition, sintering, and lower transition zone, located in sequential order. The gas temperature in the burning zone 28 is in range of approximately 1,600° F. to 3,500° F., while the material temperature in the burning zone 28 is in the range of approximately 1,750° F. to 2,700° F. The materials, having been fully converted to clinker are removed from, or near, the second end 13 of the kiln 10.

The inventors have discovered that the second mixture of material 70 can be added at a single location, or a plurality of locations, that is/are intermediate to the first end 12 and the second end 13 of the kiln 10. A relationship between the physical attributes of the kiln 10 and the location(s) wherein to add the second mixture of material 70 has been discovered to be:

17*D [symbol] L [symbol] 30*D (Eq. 1)

wherein, in Equation 1, L is the length (i.e., location) from the discharge, or second, end 13 of the kiln 10 and D, represents the interior diameter of the kiln 10. Stated alternatively, the intermediate location along the kiln 10 where adding the second mixture of materials 70 is found to be most beneficial, under this invention, is approximately in the range between 17 to 30 times the interior diameter of the kiln 10 from discharge end 13 of the kiln 10.

For example, in an embodiment wherein the kiln 10 that is 550 feet in total length with an inside diameter of 10 feet, when applying equation 1 (above), the location where to add the second material 70, is approximately anywhere from 170 to 300 feet from the discharge end 13 of the kiln 10.

In the present invention, in addition to providing a wet slurry of raw materials at the first end 12 of the kiln, a second mixture of material 70 is added to interior 11 of the operating kiln 10 at a location other than the first end 12 with the raw materials. It has been discovered by the inventors, that by adding the second mixture 70, wherein the mixture 70 has various raw materials, that include materials from the group consisting of: CaO, MgO, Al₂O₃, or Fe₂O₃.

One product that contains some of these materials that can be in the second mixture 70 is lime kiln dust (i.e., LKD). LKD, which is the by-product of the lime manufacturing process. The LKD, chemically is made up of several ingredients, but includes CaO in the amounts ranging from approximately 40% to 80% by weight.

One aspect of the invention is to add a mixture 70 within the pre-heating zone 24 or calcining zone 26. The mixture 70 can be made up entirely of LKD, or can have these other materials from the group in addition, or alternatively.

Other materials can be included with the LKD to make up the second mixture 70. For example, cement kiln dust (i.e., CKD) can be in the second mixture 70 along with the LKD. Various combinations of LKD and CKD can comprise the second mixture 70. When using CKD with LKD in the second mixture 70, various ratios of LKD to CKD, by weight, can be employed. The ratio of LKD to CKD can range from approximately 1:20 to 1:2. By varying the aforementioned ratio different properties in the resultant clinker, and concomitant cement, are obtainable. For example, by having a high ratio, a cement with a high early strength is created. Conversely, by having a lower ratio, a cement with a low early strength is obtained.

Belite is a term for the amount of C₂S, dicalcium silicate, along with impurities in the cement clinker. By varying the amount of LKD used in the present invention, the resultant belite amount varies.

Other materials that can be added with the second mixture 70 can include slag, or other raw materials with high amounts of CaO, MgO, Al₂O₃, or Fe₂O₃.

Another material that the inventors have discovered would be beneficial if added to the kiln 10 with the second mixture 70 include NH₄F₂ (i.e., ammonia bifluorite). This material can radically change the NO generation of the kiln 10, and further improve clinker production due to the use of a mineralizer (Fluorite).

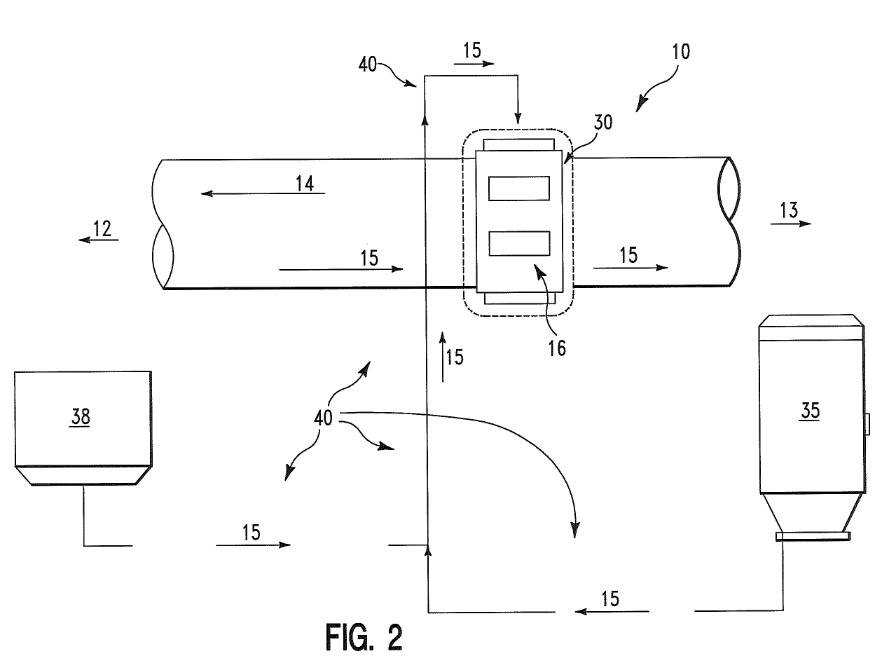

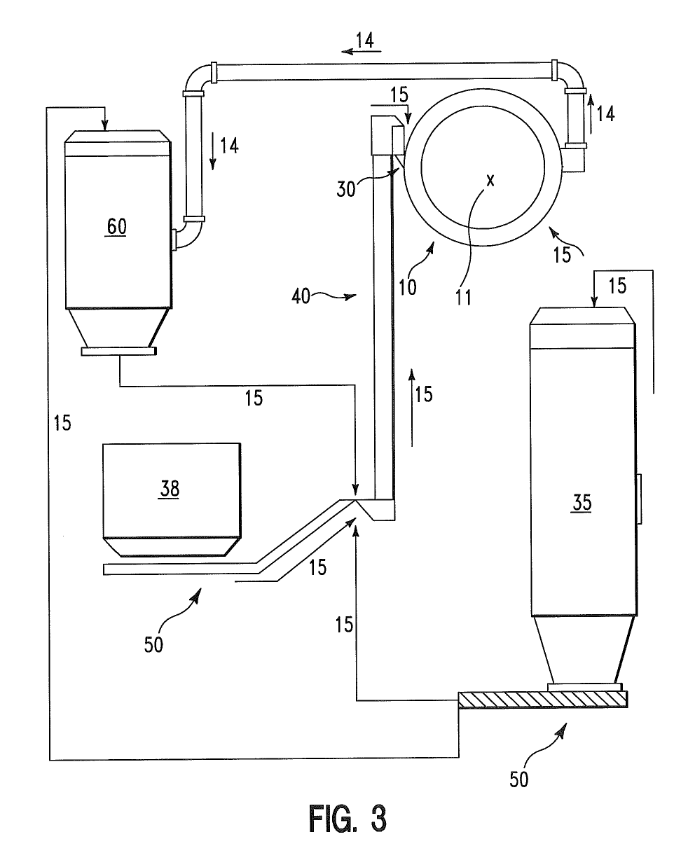

Turning to FIGS. 2 and 3 which depict various views of a diagrammatic, or schematic, view, of the kiln 10, and manufacturing system 100, in accordance with the present invention. The system 100 includes a wet rotary kiln 10, a first source of material 35, a second source of material 38, a dust collector 60, and other accouterments. The first source of material 35, may be a silo, or alleviator, containing fluidized materials such as LKD, CKD, fly ash, and the like. The LKD can be powderized in a fine dust sized in the range from a 200 mesh to a 50 mesh. The second source of material 38, may be a slag hopper containing solid materials, such as pelletized LKD, and the like.

Both the first source 35 and second source 38 have adjacent a proportioning system 50, such as a conveyor screw, for mixing, proportioning the materials as it is moved towards the kiln 10. The flow of material 15, be it from the first source 35, the second source 37, or both, leads to a conveying system 40, such as a bucket conveyor. At the distal end of the conveying system 40 are a plurality of scoops 30 that are configured to place material through a plurality of ports 16 that are located around the periphery of the kiln 10, in this embodiment, in the pre-heat zone 24.

Further in communication with the ports 16 in the pre-heat zone 24 is a dust collection system 60 that includes a system of duct collection pipes 62 and a duct collector 64.

Alternatively, the second material 70 need not be added to the interior 11 of the kiln 10, via scoops 30. That is the material 70 may be added under atmospheric pressure (e.g., scoops 30), or it may be added under pressure. For example, the second material 70 may be injected under pressure into the kiln 10.

Table 1, below, shows some examples of various second mixture of materials 70 that can be added to the kiln 10 between the first end 12 and the second end 13. Table 1 shows approximate ranges of various bulk materials that can be added as part of the second material 70 at the intermediate location on the kiln 10. As can be seen various bulk materials that are readily available may be added.

| | | | | | | | Mg |
|---|---|---|---|---|---|---|---|
| | | Marble | Alum. | Iron | | Pond | Mate- |
| | LKD | Sand | Material | Slag | Fly Ash | Ash | rial |
| SiO₂ | 2.87 | 1.21 | | | 48.25 | 50.59 | |
| CaO | 60-75% | 50-54.77 | | >20 | 1.92 | 0.86 | |
| Fe₂O₃ | 0.23 | 0.14 | 1.65 | <30.0 | 7.11 | 3.85 | |
| Al₂O₃ | 0.89 | 0.39 | 30-99% | | 20-35% | 20-35% | |
| MgO | 1.29 | 0.59 | 1.03 | | 0.87 | 0.84 | <6% |

Another aspect of the invention that has been discovered is that by adding the second material 70 to the kiln 10, the raw material introduced at the first end 12 of the kiln 10 may be altered while still resulting in a quality clinker. That is, for example, limestone that is of generally lower quality (e.g., lower CaO content) can be added at the first end 12. That is, a kiln operator need not use higher quality (e.g., more expensive) limestone product at the first end 12. Thus, the invention provides a more environmentally friendly cement making method in that inter alia materials such as LKD are disposed of and rarer, higher quality limestones are not required in order to make the cement.

As depicted in an embodiment in FIG. 6, an aspect of the invention includes the discovery that certain gas velocities are optimal in the making of the clinker via this method. In order to adequately control dust and yet concurrently pull gases out of the kiln 10 (e.g., via fan), a gas velocity of approximately no greater than 30 fps is desirous in the preheating zone 24 and/or the calcining zone 26.

Further, in the embodiment depicted, utilizing a 11% filling degree (i.e., ratio of material area:total cross-sectional area of kiln), the present method produces approximately 2,150 tons/day of clinker.

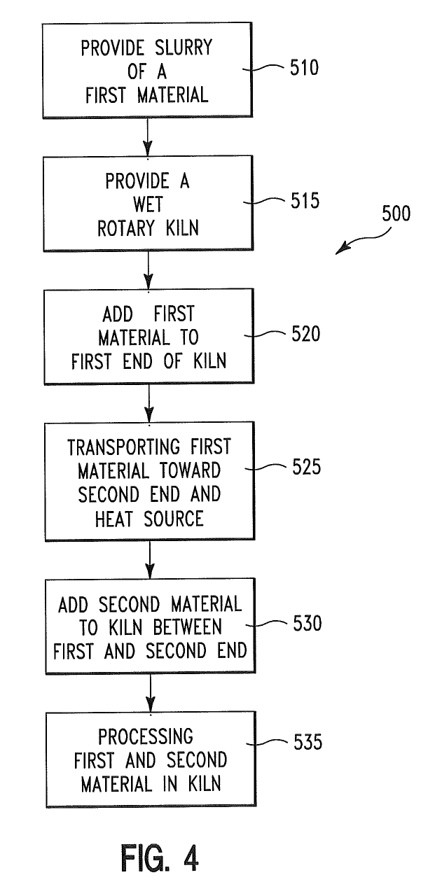

A method of the present invention is depicted in FIG. 4 comprising: providing a slurry of a first material 510; providing a wet rotary kiln 515; adding a first material to a first end of the kiln 520; transporting the first material within the kiln towards the discharge (second) end and heat source in the kiln 525; adding a second material to the kiln the first and second end 530; and, processing the mixture of the first and second material 535, which ultimate results in cement clinker.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

What is claimed is:

1. A composition comprising:
a first mixture of material including calcium, silica, aluminum, and iron, wherein said first mixture has been processed through an entire length of a rotary kiln; and
a second mixture of material including at least one selected from the group consisting of: CaO, MgO, Al₂O₃, and Fe₂O₃, wherein said second mixture has been processed through less than an entire length of said rotary kiln.

2. The composition of claim 1, wherein said second material includes lime kiln dust.

3. The composition of claim 1, wherein said lime kiln dust is pelletized.

4. The composition of claim 1, wherein said second material includes cement kiln dust.

5. The composition of claim 4, wherein said second material is a mixture of said lime kiln dust and said cement kiln dust, said mixture having a ratio of said lime kiln dust to said cement kiln dust from approximately 1:20 to 1:1.

6. The composition of claim 1, wherein said second material includes ammonia bifluorite.

7. The composition of claim 1, wherein said second material includes fly ash.

8. The composition of claim 1, wherein said lime kiln dust is powderized to a size in a range from a 200 mesh to a 50 mesh.

9. The composition of claim 3, wherein a size of said pelletized lime kiln dust is sized from approximately 32 microns to ¼″.

10. A system comprising:
a wet rotary kiln having a plurality of zones contained therein, said plurality of zones including a wet zone, a dry zone, a preheating zone, a calcining zone, and a burning zone, configured for making cement clinker, said rotary kiln having a first end and a second end, and an interior connecting therebetween, said wet zone being located between said first end and said dry zone, said dry zone being located between said wet zone and said preheating zone, said preheating zone being located between said dry zone and said calcining zone, said calcining zone being located between said preheating zone and said burning zone, said burning zone being located between said calcining zone and said second end;
a heat source located proximate said second end;
a first material entry location proximate said first end;
a first material source containing a first material;
a second material source containing a second material;
a proportioning system located adjacent to both said first material source and said second material source, wherein said proportioning system proportions said first material and said second material as said first material and said second material move towards said wet rotary kiln;
a conveying system, wherein a plurality of scoops are located at a distal end of said conveying system, said plurality of scoops configured to place said first material and said second material through a plurality of ports, wherein said plurality of ports are located on the periphery of said wet rotary kiln;
a dust collector in communication with said plurality of ports, wherein a plurality of dust collection pipes are connected to said dust collector;
a second material entry location configured for entry of said second material to an interior of said wet rotary kiln, said second material entry location residing within said preheating zone or said calcining zone, said second material entry location being located at
17*D [symbol] L [symbol] 30*D
wherein L is the length from said second end of said wet rotary kiln and D, represents said interior diameter of said wet rotary kiln.

11. The system of claim 10, wherein said second material further comprises a material selected from the group consisting of: CaO, MgO, Al₂O₃, and Fe₂O.

12. The system of claim 10, wherein said second material further comprises cement kiln dust.

13. The system of claim 12, wherein said second material is a mixture of said lime kiln dust and said cement kiln dust, said mixture having a ratio of said lime kiln dust to said cement kiln dust from approximately 1:20 to 1:1.

14. The system of claim 10, wherein said lime kiln dust is pelletized.

15. The system of claim 10, wherein said second material further comprises fly ash.

16. The system of claim 10, wherein said second material further comprises ammonia bifluorite.

17. The system of claim 10, wherein said lime kiln dust is powderized to a size in a range from a 200 mesh to a 50 mesh.

18. The system of claim 10, wherein a size of said pelletized lime kiln dust is sized from approximately 32 microns to ¼″.

19. The system of claim 10, wherein said second material entry location is approximately 300 feet to 400 feet from said second end.

20. The system of claim 10, wherein said wet zone extends from the start of said wet rotary kiln up to a length of 50 feet, further wherein a gas temperature in said wet zone is in range of approximately 700° F. to 1,000° F., while a material temperature in said wet zone is in the range of 80° F. to 400° F.

21. The system of claim 10, wherein said drying zone extends from the end of said wet zone and extends from in the range of 50 feet to 100 feet from said first end of said wet rotary kiln, further wherein a gas temperature in said drying zone is in range of 1,000° F. to 1,500° F., while a material temperature in said drying zone is in the range of 400° F. to 800° F.

22. The system of claim 10, wherein said preheating zone extends from the end of said drying zone and extends from 100 feet to 150 feet from said first end of said wet rotary kiln, further wherein a gas temperature in said preheating zone is in range of 950° F. to 1,850° F., while a material temperature in said preheating zone is in the range of 800° F. to 1,200° F.

23. The system of claim 10, wherein said calcining zone extends from the end of said preheating zone and extends from 150 feet to 400 feet from said first end of said wet rotary kiln, further wherein a gas temperature in said calcining zone is in range 2,100° F. to 3,250° F., while a material temperature in said calcining zone is in the range of 1,200° F. to 1,750° F.

24. The system of claim 10, wherein said burning zone extends from the end of said calcining zone to said second end of said wet rotary kiln, further wherein a gas temperature in said burning zone is in range of 1,600° F. to 3,500° F., while a material temperature in said burning zone is in the range of 1,750° F. to 2,700° F.

25. The system of claim 10, wherein said burning zone contains three sub-zones which include an upper transition, a sintering, and a lower transition zone, further wherein said sub-zones are located in sequential order.
